(19) United States
(12) Patent Application Publication
(10) Pub. No.: US 2008/0199580 A1
(43) Pub. Date: Aug. 21, 2008

(54) Tea maker with timer

(76) Inventors: Mario Bernardo Accumanno, East Hanover, NJ (US); Michael William Crowley, Callabash, NC (US); Richard Chang, HSI Chih Town (TW); Juan Fernandez, Towaco, NJ (US)

Correspondence Address: Gearhart Law, LLC, 4 Ferndale Rd., Chatham, NJ, 07928, US

(21) Appl. No.: 11/707,573

(22) Filed: Feb. 16, 2007

(51) Int. Cl. A47J 31/00; A23F 3/00; A47J 31/44

(52) U.S. Cl. 426/435; 99/283; 99/299

(57) ABSTRACT

A tea maker, having a receptacle supported by a base, the receptacle being suitable for receiving water from a user and suitable for containing tea leaves, an actuatable valve having open and closed positions flowably connected to said receptacle; and a timer mechanism which sets the acuatable valve into the open position after a predetermined period set by the user, thereby allowing brewed tea to flow from the receptacle into a tea vessel.

### FIELD OF THE INVENTION

The invention relates to infusion beverage makers, in particular, a single cup tea maker suitable for brewing tea for a user determined length of time.

### BACKGROUND OF THE INVENTION

The present invention relates to an infusion beverage maker comprising a receptacle for containing hot water, a timer mechanism for maintaining the hot water in contact with tea leaves for a predetermined period of time, said receptacle unit being detachably mounted on the base of the infusion beverage maker, and the timer mechanism having an actuatable valve assembly unit which controls the discharge of the infusion beverage into a vessel.

When making tea, as is known, the quality of the tea beverage depends on how long the tea leaves remain in the hot water, i.e., for how long the tea will draw. This is because up to roughly three minutes of infusion time, the tea will emit substances to the water which stimulates the circulation of a tea drinker after the consumption. When the tea stands for longer than three minutes, active substances are set free in the tea leaves which will reduce the circulation of a consumer upon consumption, which contributes to calming him or her down. Thus, controlling the time the tea brews is crucial, not only to the strength of the brew and the tea flavor, but on the medicinal effects felt by the tea drinker.

The tea maker has an optional removable basket/strainer to prevent tea leaves from stuffing up the outlet of the actuatable valve assembly, and to allow easy removal after use. Tea leaves can remain in the tea maker for one or more uses depending on the preference of the user. The basket can be removed, cleaned, and new tea leaves can be placed therein.

In addition, depending on the preference of the user, the receptacle assembly can be removed from the timer mechanism/base. Since the optimal cup of tea requires a clean brewing unit, removing the receptacle from the timer/mechanism base allows it to be cleaned, such as in a dishwasher, at regular intervals. As such, the user can maintain the unit free of residues that will ruin the flavor of the tea.

The removable receptacle assembly can be filled with hot water at one location and transported to the timer mechanism/base located elsewhere. A valve in the receptacle assembly closes when the receptacle assembly is removed from the timer mechanism/base forming a water tight seal which prevents water flowing through the orifice. A lid which covers the receptacle assembly keeps the hot water from spilling out of the receptacle assembly from the top. When the receptacle assembly is refitted to the timer mechanism/base, the receptacle valve abuts and flowably connects to the acutatable valve in the timer mechanism. Thus, the receptacle can be located above the timer mechanism/base, allowing for a simpler, less complicated and more reliable method of releasing the brewed tea than other tea makers, such as described in U.S. Pat. No. 6,802,246.

To keep to a specific tea infusion time, it is furthermore arranged that the actuatable valve assembly remains in a closed position during the tea's infusion time, and that after the brewing cycle is complete the actuatable valve moves to an open position allowing brewed tea to flow through an orifice into a vessel.

Because of the tea maker's small size, there is no need to use a large container or carafe for receiving the brewed tea. The filling of a tea cup prevents the tea from cooling off too much, as when it is put into an intermediate storage in a carafe or jug. Moreover, since the user supplies the hot water, there are no external power requirements for electrical components such as hot plates or heating elements. This reduces the complexity and the cost of the tea maker, and helps make the unit more affordable.

It is therefore an object of the invention to provide a method of controlling the amount of time a single cup of tea is brewed.

It is another object of the invention to provide a tea maker where the user determines the brewing cycle for a cup of tea.

It is also an object of the invention to teach a tea maker that has a removable receptacle, for transporting hot water or for cleaning.

Another object of the invention is to teach a tea maker that does not rely on external power requirements for heating elements or hot plates.

One object of the invention is to provide a simple, affordable tea maker for brewing individual cups of tea.

It is another object of the invention to provide a tea maker having a simplified mechanism for releasing the brewed tea from the receptacle to a vessel.

It is a further object of the invention to teach a tea maker having a receptacle located above a timer mechanism and base.

Furthermore, it is an object of the invention to have teach a tea maker having an improved acuatable valve.

One embodiment of this invention is illustrated in the accompanying drawings and will be described in more detail herein below.

### SUMMARY OF THE INVENTION

A tea maker, comprising a receptacle supported by a base, the receptacle being suitable for receiving water from a user and suitable for containing tea leaves, an actuatable valve having open and closed positions flowably connected to said receptacle; and a timer mechanism which sets the acuatable valve into the open position after a predetermined period set by the user, thereby allowing brewed tea to flow from the receptacle into a tea vessel.

### BRIEF DESCRIPTION OF THE DRAWINGS

FIG. 1 is a perspective view of a preferred embodiment of the invention, showing a receptacle assembly, timer mechanism and base.

FIG. 2 is a front view of a preferred embodiment of the invention, showing a receptacle assembly, timer mechanism and base.

FIG. 3 is a right side view of a preferred embodiment of the invention, showing a receptacle assembly, timer mechanism and base.

FIG. 4 is a left side view of a preferred embodiment of the invention, showing a receptacle assembly, timer mechanism and base.

FIG. 5 is a top view of a preferred embodiment of the invention, showing a receptacle assembly.

FIG. 6 is a bottom view of a preferred embodiment of the invention, showing a base.

FIG. 7 is a rear view of a preferred embodiment of the invention, showing a receptacle assembly, timer mechanism and base.

FIG. 8 is an exploded perspective view of a preferred embodiment of the invention, showing a basket, a receptacle assembly removed from the timer mechanism, and the base.

FIG. 9 is an exploded perspective view of a preferred embodiment of the invention, showing an exploded view of the receptacle assembly, an exploded view of the timer mechanism and an exploded view of the base.

FIG. 10 is a front view of a preferred embodiment of the invention showing the movement of the turn handle during operation of the invention.

### DESCRIPTION OF THE PREFERRED EMBODIMENTS

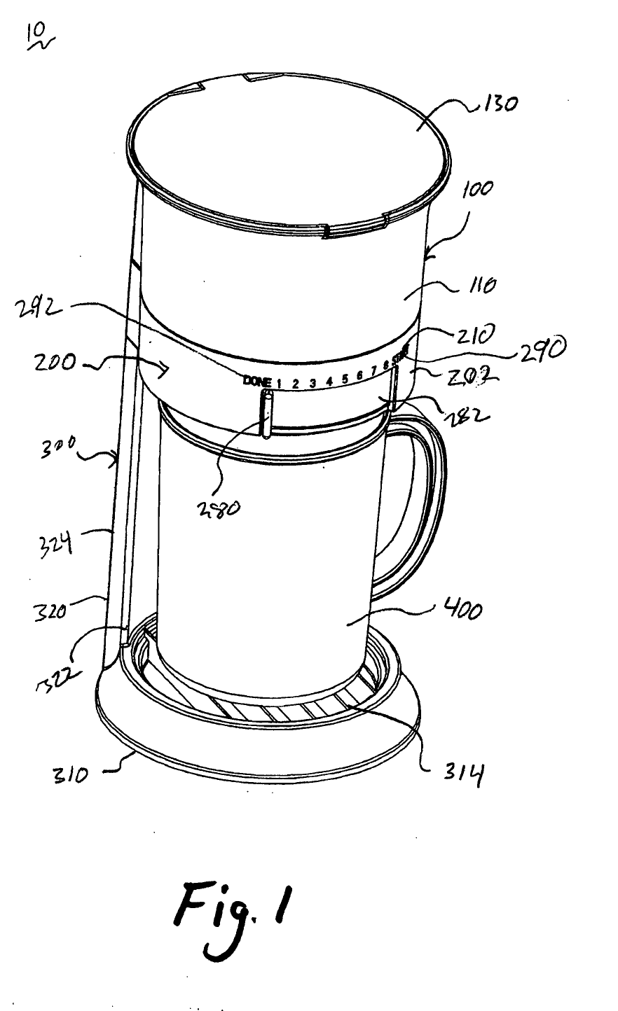

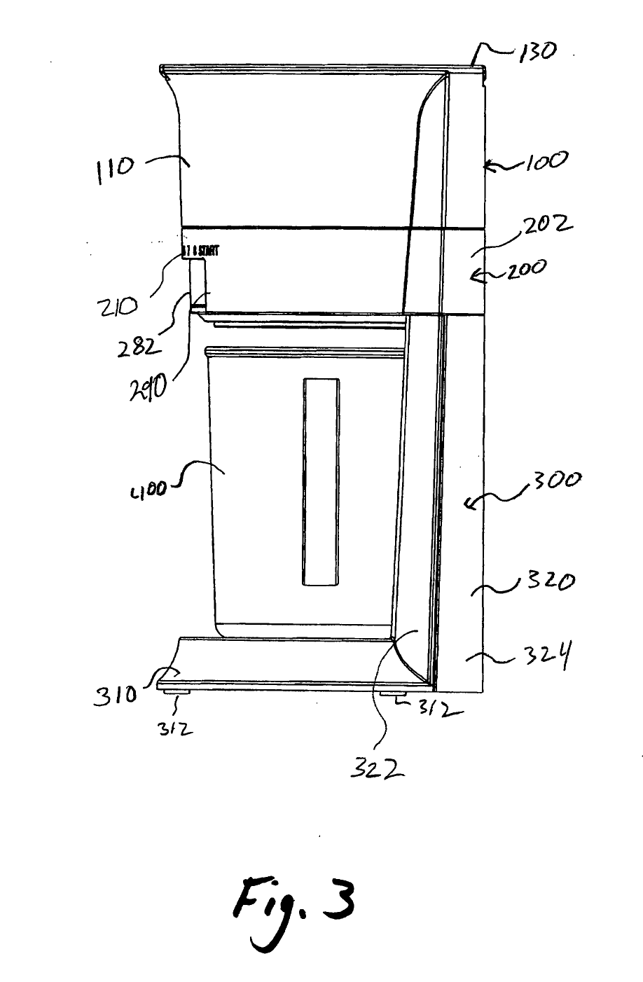

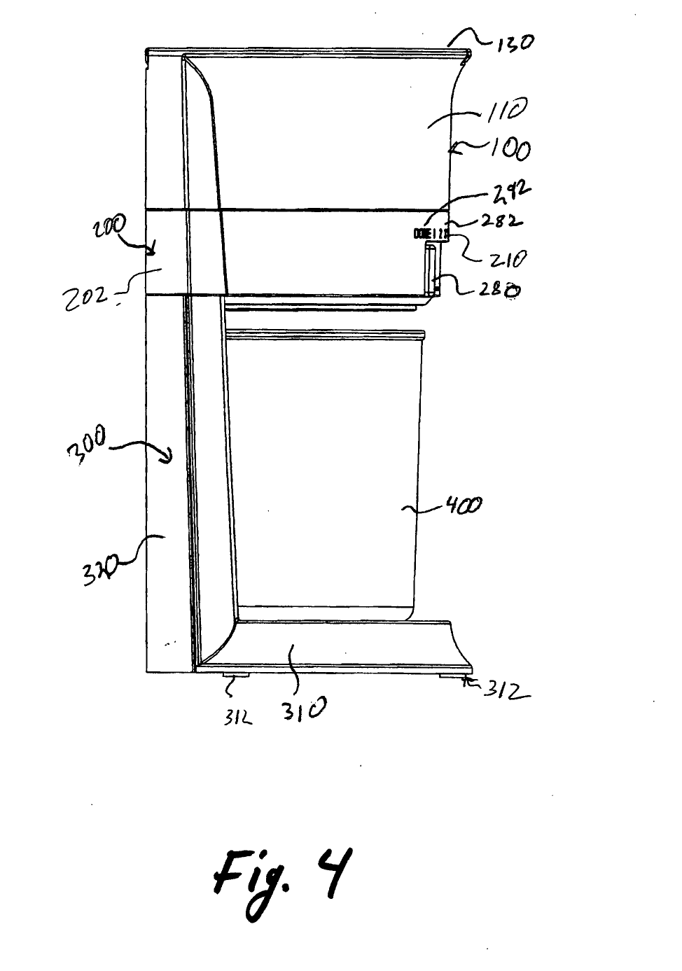

The preferred embodiments of the present invention will now be described with reference to FIG. 1-10 of the drawings. Identical elements in the various figures are identified with the same reference numerals.

Referring now to the drawings, FIG. 1, shows the invention 10, having receptacle assembly 100, timer mechanism assembly 200, and base 300.

Receptacle assembly 100, has receptacle 10, and top cover 130. Timer mechanism assembly 200 has timer cabinet 202, handle 280 and rotator 282. Base assembly 300 has bottom 310, ribs 314, support 320, support front 322, and support rear 324. Also shown resting on bottom 310 is vessel 400. FIG. 1 also shows marks 210, start position 290 and done position 292.

The individual components of the invention, such as receptacle assembly 100, timer mechanism assembly 200 and base 300 can be made of any suitable material such as metal, plastic or glass, but are preferably molded from plastic, more preferably high impact plastics such as polypropylenes or polystyrenes. The materials can be dyed or colored or can be transparent or translucent, and should be able to routinely withstand temperatures of at least 212 degrees Fahrenheit.

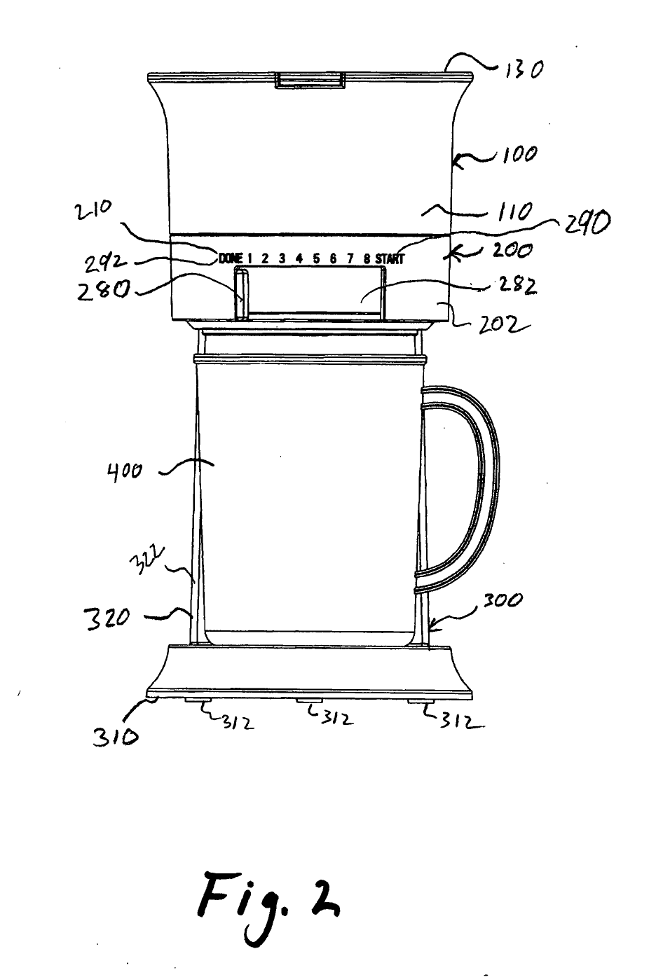

FIGS. 2 to 4 shows receptacle assembly 100, having receptacle 110, and top cover 130. Receptacle 110 preferably holds up to 16 ounces of water. Timer mechanism assembly 200 has timer cabinet 202, handle 280 and rotator 282. Base assembly 300 has bottom 310, grommets 312, ribs 314, support 320, support front 322, and support rear 324. Also shown resting on bottom 310 is vessel 400. FIG. 12 also shows marks 210, start position 290 and done position 292.

Vessel 400 can be any cup or container suitable for drinking tea. It could be designed and packaged to compliment the design features of the invention, or the user could supply a cup of his or her choice.

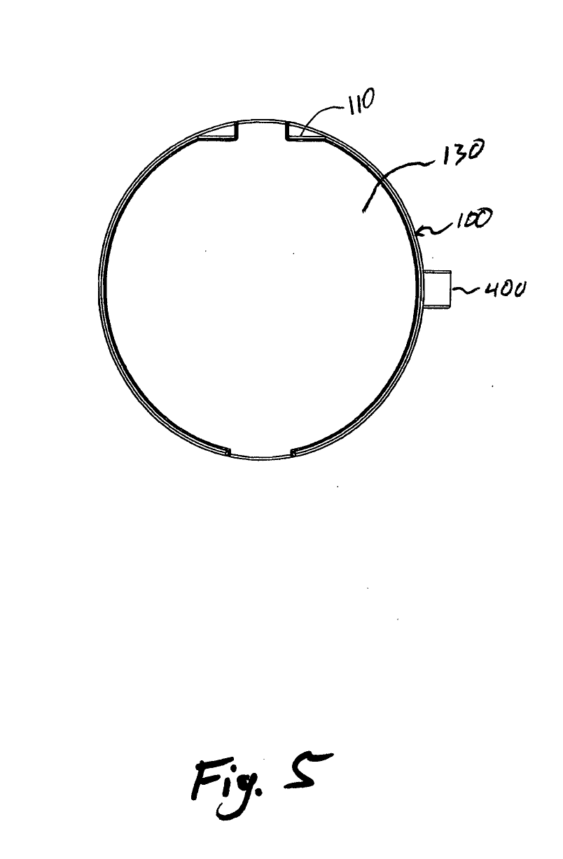

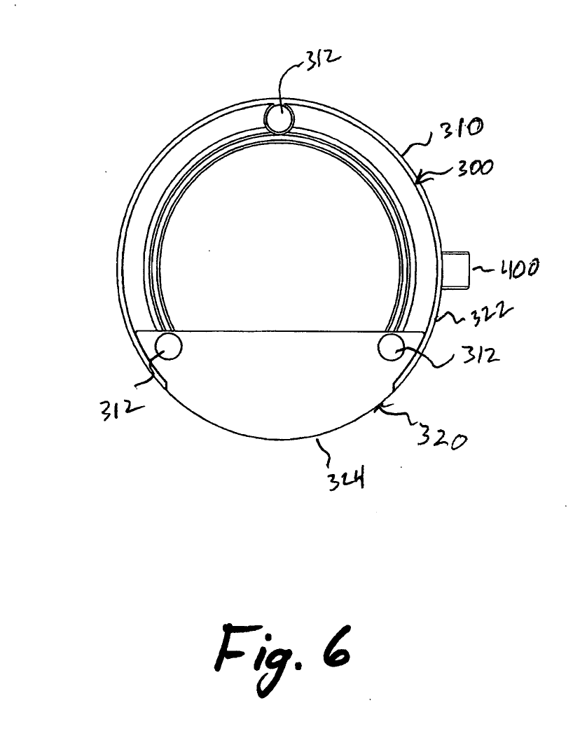

FIG. 5 shows lid 130, receptacle assembly 100, receptacle 110 and vessel 400. FIG. 6 shows base 300, bottom 310, grommets 312, support 320, support front 322, support rear 324, and vessel 400.

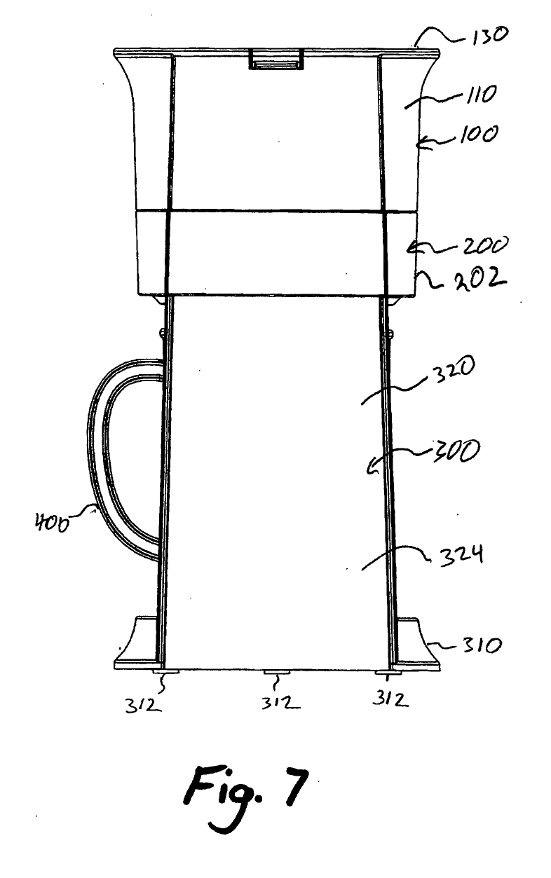

FIG. 7 is a rear view showing receptacle assembly 100, having receptacle 110, and top cover 130. Timer mechanism assembly 200 has timer cabinet 202. Base assembly 300 has bottom 310, grommet 312, support 320, and support rear 324. Also shown resting on bottom 310 is vessel 400.

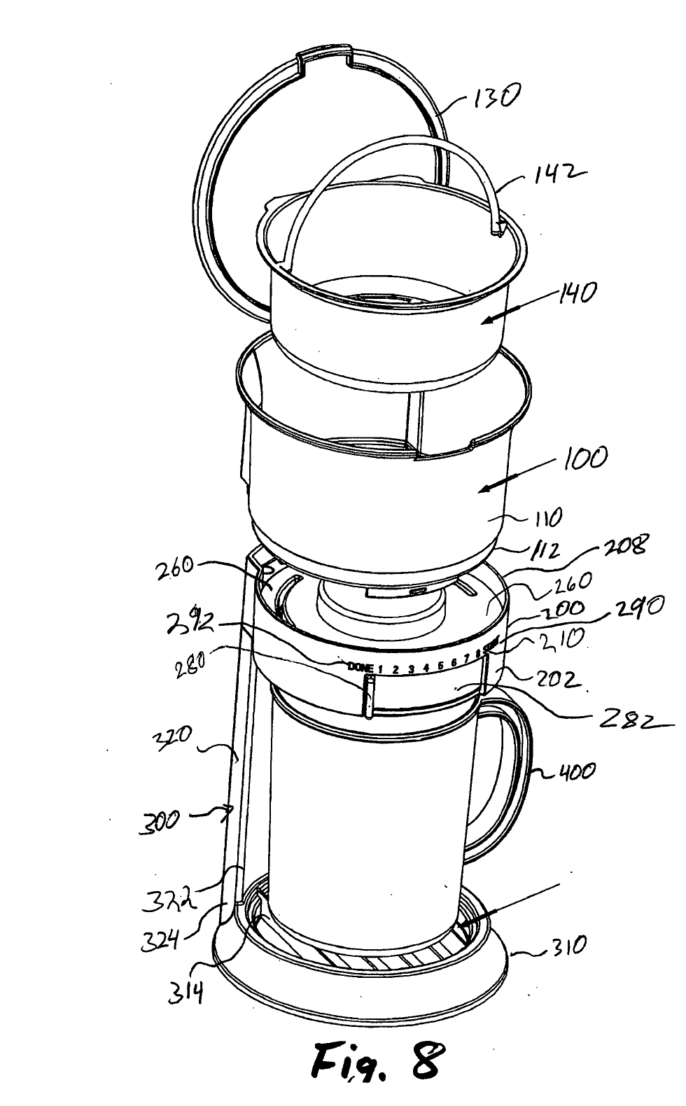

FIG. 8 is an exploded perspective view showing receptacle assembly 100, receptacle 110, positioning groove 112, and top cover 130. Also seen are basket filter 140 and basket handle 142. Timer mechanism assembly 200, has timer cabinet 202, cabinet lip 208, timer marks 210, with start position 290 and done position 292. Timer mechanism assembly 200 has mechanism timer cover 260, turn handle 280, rotator 282, base assembly 300, bottom 310, ribs 314, support 320, support front 322 and support rear 324. Also seen is vessel 400.

Positioning groove 122 allows receptacle assembly 100 to be conformingly fitted into timer mechanism assembly 200. Timer mechanism assembly 200 has cabinet lip 208. When the user desires to place receptacle assembly 100 into timer mechanism assembly 200, say after the receptacle has been removed for cleaning in a dishwasher, the user aligns positioning groove 122 with cabinet lip 208, and slides the receptacle assembly 100 into the timer mechanism assembly 200.

The purpose of optional basket 140 is to contain tea leaves, and to allow the easy placement and removal of tea leaves to and from the receptacle 110. It should be designed to allow water to flow through the tea and into the receptacle 110. It can be constructed in any number of configurations and materials. For example, basket 140 could be made of plastic or metal, could have sides with or without holes, and/or bottoms with or without holes. It can be constructed of a single piece of molded plastic or multiple pieces, or it could be constructed of a metal mesh material. Basket 140 may also have a handle 142, as seen in FIG. 8, however, the handle can be of any suitable configuration. As an alternative to basket 140, the user may use disposable filter made from paper or the like.

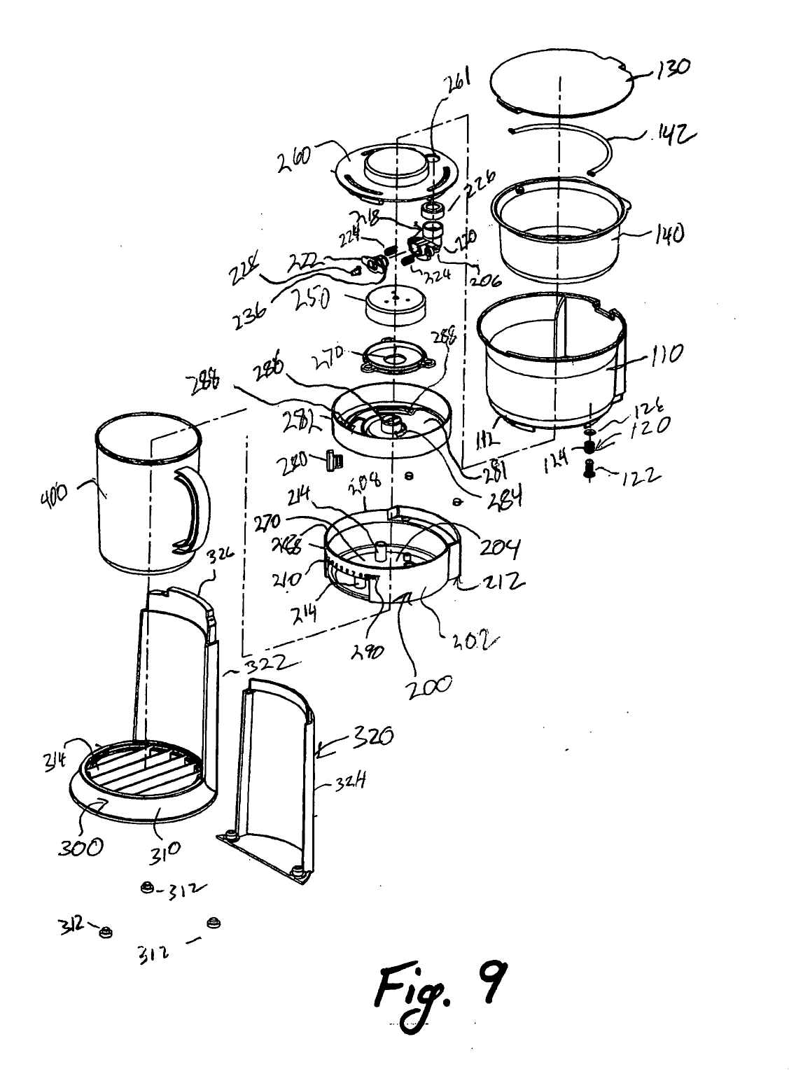

FIG. 9 shows receptacle assembly 100 having receptacle 110, positioning groove 112, top cover 130, basket filter 140, and basket handle 142. Optional receptacle water valve 120 has water valve pole 122, tank spring 124, and tank o ring 126. Valve pole 122 has valve cap 121. In a preferred configuration, tank spring 124 is placed around water valve pole 122, and inserted from below the receptacle 110 into an orifice (not shown) in receptacle 110. 0 ring 126, or other fastening means is put over valve cap 121, and prevents tank spring 124 from pushing valve pole out of the orifice, retaining valve pole 122. The tank spring 124 forces valve cap 121 against the bottom of receptacle 110, sealing receptacle 110 when it is full of water.

Receptacle valve 120 is positioned so that when receptacle assembly is fitted to timer mechanism assembly 200, it mates with actuatable valve 220. When the receptacle valve mates with actuatable valve 220, it is pushed up, against the force of tank spring 124. This puts receptacle valve 120 into the open position. In this position water or brewed tea can flow from the receptacle 110 through receptacle valve 120, and into acutatable valve 220.

Actuatable valve 218 has valve casing 220, valve shaft 222, springs 224, rubber seal 226, valve shaft pin 228, spring water valve 230, small o ring 236, and drain orifice 206. Valve casing 220 has only one moving part, valve shaft 222, and it is contained within the valve casing 220. No other parts are necessary. This makes opening and closing the acutatable valve 218 simple, straightforward and reliable. Valve shaft 222 fits into valve casing 220, with springs 224 applying opposing force. Valve shaft pin 228 is attached to valve shaft 222, and can be a separate piece as shown or integrally molded onto valve shaft 222. When valve shaft pin 228 is pushed in a direction opposing the force of springs 224, the acutatable valve 218 is in the open position, and fluids can pass through the actuatable valve 218 through drain orifice 206 and into vessel 400. When pressure against valve shaft pin 288 is relieved, the springs 224 expand and move valve shaft 222 into the closed position, preventing fluids from passing through actuatable valve 218 and into vessel 400.

Timer mechanism assembly 200 has timer cabinet 202, timer cabinet bottom 204, cabinet lip 208, timer marks 210, recess 212, posts 214, timer 250, timer cover 260, timer bottom 270, turn handle 280, cavity 281, rotator 282, cam 284, timer catch 286, post slot 288. Also shown are start position 290 and done position 292. It also has actuatable valve 218.

Timer mechanism assembly 200 has timer cabinet 202. Rotator 282 rests on timer cabinet bottom 204. Rotator 282 has attached turn handle 280, which can be integrally molded with rotator 282 or attached separately as shown. When a user exerts lateral force on turn handle 280, rotator 282 moves right or left, as far as start position 290 or done position 292. Timer cabinet 202 also has posts 214. Posts 214 are likely molded into timer cabinet 202, and are fastened to timer bottom 270. Rotator 282 has post slots 288 which allow rotator 282 to move without interfering with posts 214. Timer 250 rests on timer bottom 270. Timer 250 mates with timer catch 286 on rotator 282, so that when turn handle 280 is moved, catch 286 engages timer 250, rotating the timer with it. Acutatable valve 218 attaches to timer cabinet bottom 204. Rotator 282 has cavity 281 to accommodate actuatable valve 218 when rotator 282 rotates. Timer cover 260 has an orifice 261 that mates with acutatable valve 218 at seal 226.

Rotator 282 also has cam 284. When timer mechanism assembly 200 is assembled, cam 284 abuts valve shaft pin 228. Movement of cam 284 opens and closes actuatable valve 218. Cam 284 is most likely designed so that when the user rotates rotator 284 to the far right with turn handle 280, to start position 290, the cam 284 allows acutatable valve 218 to move to a closed position. When the user releases turn handle 280, the timer 250 begins to turn, moving rotator 284 laterally to the left. When turn handle 280 reaches done position 292, cam 284 allows acutatable valve 218 to open releasing tea from receptacle 110. Optionally, timer mechanism assembly 200 can have a catch that holds turn handle 280 in the start position 290 indefinitely, until the user moves it a predetermined distance to the left.

Base assembly 300 has bottom 310, grommets 312, ribs 314, support 320, support front 322, support rear 324, support projection 326 and vessel 400. Support 320 can be separate molded pieces, comprising support front 322 and support rear 324, or a single integrally molded piece, or multiple molded pieces. Support projection 326 fits into recess 212, connecting base assembly 300 to timer mechanism assembly 200. Base 300 has optional ribs 314. Ribs 314 can catch extra water or tea that spill from vessel 400 or from timer mechanism assembly 200 or receptacle assembly 100. The ribs 314 allow the water or tea to collect without substantially wetting the bottom of vessel 400. Alternatively, ribs 314 could be replaced with grooves or with a separate molded ring or disk having holes or slots that allow water or tea to flow into a reservoir molded into base 300.

As stated receptacle assembly 100 is preferably removable from timer mechanism assembly 200. When the receptacle assembly 100 is removed from timer mechanism assembly 200, receptacle water valve 120 closes. This allows the user to fill the receptacle assembly 100 with water, and transport the filled receptacle assembly 100 to timer mechanism assembly 200 and base assembly 300 without water leaking out of receptacle assembly 100. In addition, if receptacle assembly 100 is removable, then it can be cleaned easily, either by hand or in a dishwasher. Optional lid 130, if closed, can keep hot water from spilling out of receptacle 110, when being moved from the hot water source to the timer mechanism/base.

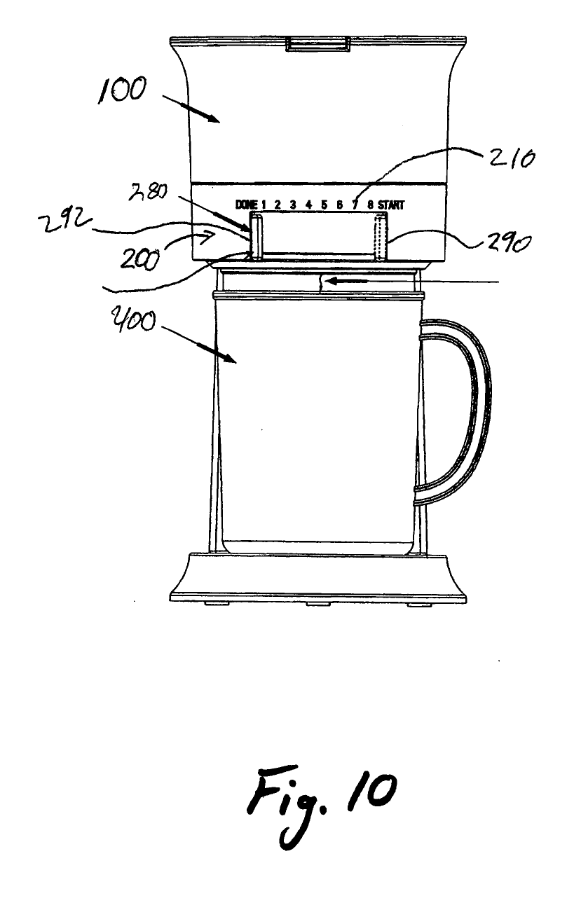

In order to use the preferred present invention, the user places tea leaves in basket 140. The user moves turn handle 280 to the far right hand, i.e. start position 290 as seen in FIG. 10. The movement causes rotator 282 to rotate cam 284, positioning it against valve shaft pin 228, putting acutatable valve 218 in the closed position. The user then pours boiling water into receptacle assembly 100, and moves turn handle 280 toward the left to the desired position, using marks 210 on timer bottom 270 as a reference. After releasing turn handle 289, the user waits until rotator 282 moves to the far most right position, i.e., done position 292. When in the done position 292, cam 284 activates actuatable valve 218 to the open position, allowing the brewed tea to flow through to vessel 400. A preferred brewing time is about 3 minutes, with a typical brewing range being between 1 and 5.5 minutes, depending on the preference of the user. Marks 210 should be correlated with the elapsed time of timer 250, so that, for example moving the turn handle 284 to the 3 minute mark corresponds to a brewing time of 3 minutes.

Of course, other embodiments are possible and the method of opening and closing the actuatable valve 218 can be accomplished in any number of ways which would be apparent to the skilled artisan. For example an electronic timer having solenoid actuated valves, could be substituted for the mechanical timer. Other configurations, activating mechanisms, gates, valves etc would be apparent to the skilled artisan and are expected to fall within the scope of the invention described herein, so long as they rely on variations of an acuatable valve similar to the one described herein.

It's important to note that the invention provides a very simple and economical method of brewing tea. The construction is simple and straight forward and does not rely on an external power source or heating elements to brew a cup of tea.

While the invention as shown is suitable for brewing a single cup of tea, it is possible to construct larger units capable of brewing 2, 3 or more cups simultaneously, adapting the principles of the invention as articulated herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

We claim:

1. A tea maker, comprising:
a receptacle supported by a base, the receptacle being suitable for receiving water from a user and suitable for containing tea leaves;
an actuatable valve having open and closed positions flowably connected to said receptacle; and
a timer mechanism positioned which sets the acuatable valve into the open position after a predetermined period set by the user, thereby allowing brewed tea to flow from the receptacle into a tea vessel.

2. The tea maker of claim 1, wherein the timer mechanism has a mechanical timer.

3. The tea maker of claim 1, wherein the timer mechanism is an electronic timer having a solenoid activated valve.

4. The tea maker of claim 1, wherein the receptacle contains a removable basket suitable for containing tea leaves.

5. The tea maker of claim 1, wherein the receptacle is removable from the base.

6. The tea maker of claim 5, wherein the receptacle has a bottom, and said receptacle bottom has a receptacle valve that closes when said receptacle is removed from said base, and opens when said receptacle is fit onto said base.

7. The tea maker of claim 1, wherein the receptacle has a closable lid.

8. The tea maker of claim 1, wherein the timer mechanism has a cam that opens and closes the actuator valve.

9. The tea maker of claim 1, wherein the base contains ribs.

10. The tea maker of claim 1, wherein the water is heated by the user before being poured into said receptacle.

11. The tea maker of claim 1, wherein the receptacle holds up to 16 ounces of water.

12. The tea maker of claim 1, wherein the timer mechanism is positioned between the receptacle and the base.

13. A tea maker, comprising:
a receptacle supported by a base, the receptacle being suitable for receiving water from a user and suitable for containing tea leaves;
an actuatable valve having open and closed positions flowably connected to said receptacle; and
a timer mechanism which sets the acuatable valve into the open position after a predetermined period set by the user.

14. The tea maker of claim 13, wherein the timer mechanism has a mechanical timer.

15. The tea maker of claim 13, wherein the timer mechanism is an electronic timer having a solenoid activated valve.

16. The tea maker of claim 13, wherein the receptacle contains a removable basket suitable for containing tea leaves.

17. The tea maker of claim 13, wherein the receptacle is removable from the base.

18. The tea maker of claim 17, wherein the receptacle has a bottom, and said receptacle bottom has a receptacle valve that closes when said receptacle is removed from said base, and opens when said receptacle is fit onto said base.

19. The tea maker of claim 13, wherein the receptacle has a closable lid.

20. The tea maker of claim 13, wherein the timer mechanism has a cam that opens and closes the actuator valve.

21. The tea maker of claim 13, wherein the base contains ribs.

22. The tea maker of claim 13, wherein the water is heated by the user before being poured into said receptacle.

23. The tea maker of claim 13, wherein the receptacle holds up to 16 ounces of water.

24. The tea maker of claim 13, wherein the timer mechanism is positioned between the receptacle and the base.

25. A method of making tea, comprising the steps of:
heating water from an independent source;
pouring the water into a receptacle supported by a base, the receptacle being suitable for containing tea leaves;
setting a timer mechanism that acutates an actuatable valve, said valve having open and closed positions and maintained in the closed position by a cam;
whereby the timer mechanism moves the cam into a position opening the valve when it completes a user determined brewing cycle; and
the open valve thereby allows brewed tea to flow from the receptacle into a tea vessel.

26. The method of claim 25, wherein the timer mechanism has a mechanical timer.

27. The method of claim 25, wherein the timer mechanism is an electronic timer having a solenoid actuated valve.

28. The method of claim 25, wherein the receptacle contains a removable basket suitable for containing tea leaves.

29. The method of claim 25, wherein the receptacle is removable from the base.

30. The method of claim 29, wherein the receptacle has a bottom, and said receptacle bottom has a receptacle valve that closes when said receptacle is removed from said base, and opens when said receptacle is fit onto said base.

31. The method of claim 25, wherein the receptacle has a closable lid.

32. The method of claim 25, wherein the timer mechanism has a brew cycle of from 1 to 5.5 minutes.

33. The method of claim 25, wherein the base contains ribs.

34. The method of claim 25, wherein the receptacle holds up to 16 ounces of water.
